(19) United States
(12) Patent Application Publication
(10) Pub. No.: US 2021/0072478 A1
(43) Pub. Date: Mar. 11, 2021

(54) Lateral Pressure Resistant Remote Optical Cable

(71) Applicant: Hengtong Optic-Electric Co., Ltd., Jiangsu (CN)

(72) Inventors: Bei Jiang, Jiangsu (CN); Yuliang Wang, Jiangsu (CN); Peidong Liu, Jiangsu (CN); Weifeng Lin, Jiangsu (CN); Xinyuan Zhang, Jiangsu (CN); Liguo Gu, Jiangsu (CN); Di Wu, Jiangsu (CN); Huaqing Fei, Jiangsu (CN); Bin Luo, Jiangsu (CN)

(21) Appl. No.: 16/635,822

(22) PCT Filed: Jul. 30, 2019
(86) PCT No.: PCT/CN2019/098419

§ 371 Date: Jan. 31, 2020

(30) Foreign Application Priority Data
Aug. 1, 2018 (CN) 201810866357.6

(51) Int. Cl. G02B 6/44

(52) U.S. Cl. CPC G02B 6/4432; G02B 6/4436; G02B 6/4494

(57) ABSTRACT

Provided is a lateral pressure resistant remote optical cable, including an outer sheath, at least one loosen tube and optical fibers, wherein raw materials of the loose tube are of the following formula: 80-120 parts of PBT, 25-40 parts of PU, 40-80 parts of LLDPE-g-GMA, 1-3 parts of modified graphite nanosheets, and 2-8 parts of chopped carbon fibers, wherein the modified graphite nanosheets have a diameter of 60-150 nm, and a thickness of 2.5-8 nm; the chopped carbon fibers have a length of 2-15 μm, and a length-diameter ratio of 10-30; the loosen tube is prepared through the following steps: heating formula amount of PBT, PU and LLDPE-g-GMA and uniformly stirring them till the raw materials are completely molten; maintaining the temperature and adding the chopped carbon fibers while stirring; adding the modified graphite nanosheets, and keeping stirring; then transferring a melt into an extruder to obtain the loosen tube.

### CROSS-REFERENCE TO RELATED APPLICATION

The present disclosure claims the priority to the Chinese patent application with the filing number 201810866357.6, filed on Aug. 1, 2018 with the Chinese Patent Office, and entitled “Lateral Pressure Resistant Remote Optical Cable”, the contents of which are incorporated by reference herein in entirety.

### TECHNICAL FIELD

The present disclosure relates to the technical field of communication optical cables, in particular to a lateral pressure resistant remote optical cable.

### BACKGROUND ART

With the boom of construction of 4G, 5G communication base stations in our country, remote optical cables currently have been used in a large scale. At present, conventional remote optical cables in the market have a basic working temperature of −40° C.˜+80° C., and a flattening force value at the level of 1000 N/10 cm, but with the increasingly wide network coverage, the remote optical cables increasingly need to be used in complex areas and complex scenarios such as outdoor mountainous areas, deserts, and ocean platforms. For optical cables in outdoor scenarios such as mountainous areas and iron towers, there may be problems of vehicle crushing, injuries caused by heavy object cracking and so on; in indoor cabling channels, as the number of optical cables is increased, there is also the problem of enduring a higher pressure for the optical cables. Therefore, requirement for high lateral pressure resistant performance is an essential solution.

Therefore, for deficiencies in the prior art, it is necessary to provide a novel lateral pressure resistant remote optical cable, which can ensure that the optical cable still can maintain the optical transmission performance unaffected when the lateral pressure is 10000 N/10 cm.

### SUMMARY

Technical problems to be solved by the present disclosure at least include providing a lateral pressure resistant remote optical cable. Compared with the prior art, this optical cable has excellent lateral pressure resistance, and can ensure that the optical transmission performance still can be maintained unaffected when the lateral pressure of the optical cable is 10000 N/10 cm.

The present disclosure provides a lateral pressure resistant remote optical cable, including an outer sheath, at least one loose tube provided inside the outer sheath and optical fibers filled in the loose tube,

raw materials of the loose tube are of the following formula: 80-120 parts of PBT, 25-40 parts of PU, 40-80 parts of LLDPE-g-GMA, 1-3 parts of modified graphite nanosheets, and 2-8 parts of chopped carbon fibers, wherein the modified graphite nanosheets have a diameter of 60-150 nm, and a thickness of 2.5-8 nm; the chopped carbon fibers have a length of 2-15 μm, and a length-diameter ratio of 10-30;

the loose tube is prepared through following steps:

adding formula amount of PBT, PU and LLDPE-g-GMA into a container, heating them to a temperature of 240-300° C., and evenly stirring them for 4-8 h, such that the raw materials are completely molten; keeping the temperature at 250-280° C., slowly adding the chopped carbon fibers while stirring, and stirring the mixture for 1-2 h; subsequently adding the modified graphite nanosheets, and stirring them for 0.5-1 h; then transferring a melt to an extruder for extrusion, with an extrusion temperature being controlled at 230-260° C., and an extrusion speed being controlled at 160-200 m/min, to obtain the loose tube.

In one or more embodiments, the loose tube is prepared by following raw materials in parts by weight: 90-100 parts of PBT, 30-38 parts of PU, 60-80 parts of LLDPE-g-GMA, 8-12 parts of modified graphite nanosheets, and 5-6 parts of chopped carbon fibers.

In one or more embodiments, a ratio of PBT to LLDPE-g-GMA is within a range of 2.5-6.

In one or more embodiments, a ratio of PBT to LLDPE-g-GMA is within a range of 2.57-4.8.

In one or more embodiments, the loose tube is prepared by following raw materials in parts by weight: 90-110 parts of PBT, 30-38 parts of PU, 40-60 parts of LLDPE-g-GMA, 0.5-2 parts of modified graphite nanosheets, and 4-6 parts of chopped carbon fibers.

In one or more embodiments, the modified graphite nanosheets have a diameter of 80-120 nm, and a thickness of 4-6 nm; and the chopped carbon fibers have a length of 5-12 μm, and a length-diameter ratio of 18-25.

In one or more embodiments, a preparation method of the modified graphite nanosheets includes following steps:

(1) acidifying the graphite nanosheets to obtain acidified graphite nanosheets;

(2) ultrasonic dispersion in a medium; and

(3) adding dicyclohexylcarbodiimide and polydimethylsiloxane, reacting for at least 6 h at 75-80° C. while stirring.

In one or more embodiments, a preparation method of the modified graphite nanosheets includes following step:

adding the graphite nanosheets to a mixed solution of sulfuric acid and nitric acid, wherein a volume ratio of sulfuric acid to nitric acid is 3:1; carrying out reaction at 50-65° C. for at least 6 h, after suction filtration and alcohol washing, drying the mixture in vacuum at 70-80° C. for 4-6 h, to obtain acidified graphite nanosheets; then adding 50-80 mg of the acidified graphite nanosheets to 20 ml of tetrahydrofuran to undergo ultrasonic dispersion while stirring; subsequently adding 15-20 mg of dicyclohexylcarbodiimide and 80-90 mg of polydimethylsiloxane, and heating them to a temperature of 75-80° C. while stirring; after reaction for 12-24 h, washing a product with methanol and DMF in turn, subsequently filtering the product with a filter membrane, drying a filtration product in vacuum at 50-60° C. to obtain the modified graphite nanosheets.

In one or more embodiments, the loose tube has an outer diameter of 2.5 mm-3.0 mm, and a wall thickness of 0.45 mm-0.55 mm.

In one or more embodiments, the loose tube is filled therein with an ointment or water blocking yarns.

In one or more embodiments, the loose tube is wrapped by a water blocking reinforcement layer outside, and the water blocking reinforcement layer is made from water blocking type reinforcement fibers,

and/or

mixed fibers containing common reinforcement fibers and water blocking yarns.

In one or more embodiments, the water blocking type reinforcement fibers are aramid yarns, ultra-high strength PE fiber yarns, basalt fiber yarns or thermosetting glass fiber yarns.

In one or more embodiments, the water blocking reinforcement layer is wrapped by an elastic spiral coil outside.

In one or more embodiments, the outer sheath is a flame retardant, low-smoke, non-halogen outer sheath, which has an outer diameter of 5.0 mm-5.5 mm.

In one or more embodiments, a lateral pressure resistant capacity of the lateral pressure resistant remote optical cable is greater than 1000 N/10 cm.

The present disclosure at least has following beneficial effects:

For the lateral pressure resistant remote optical cable in the present disclosure, PU and LLDPE-g-GMA are introduced to the conventional raw materials PBT of the loose tube for blending modification. LLDPE has excellent mechanical performances, but has unsound compatibility with a PBT substrate, while an epoxy group in GMA can react with terminal carboxyl in PBT, thus improving compatibility of LLDPE with PBT, thereby facilitating improvement on the mechanical strength of PBT; moreover, PU can endow the PBT substrate with excellent damping and buffer performances, and good compression load resistance and deformation restorability. The modified graphite nanosheets and the chopped carbon fibers are uniformly distributed in the PBT substrate material, further increasing the mechanical performances of the PBT substrate. Consequently, the lateral pressure resistant remote optical cable in the present disclosure still can maintain the optical transmission performance unaffected when bearing a lateral pressure of 10000 N/10 cm.

### BRIEF DESCRIPTION OF DRAWINGS

In order to more clearly illustrate technical solutions of embodiments of the present disclosure, accompanying drawings which need to be used for the embodiments will be introduced below briefly. It should be understood that the accompanying drawings below merely show some embodiments of the present disclosure, and therefore should not be considered as limitation on the scope. A person ordinarily skilled in the art still could obtain other relevant accompanying drawings according to these accompanying drawings, without inventive efforts.

FIG. 1 is a cross-section schematic diagram of a remote optical cable in an embodiment of the present disclosure;

FIG. 2 is a cross-section schematic diagram of another remote optical cable in an embodiment of the present disclosure; and

FIG. 3 is a cross-section schematic diagram of another remote optical cable in an embodiment of the present disclosure.

In the accompanying drawings: 100. outer sheath; 200. elastic spiral coil, 300. water blocking reinforcement layer; 400. loosen tube; 500. optical fiber; 600. ointment; 700. water blocking yarn.

### DETAILED DESCRIPTION OF EMBODIMENTS

The present disclosure is further described below in combination with the accompanying drawings and particular embodiments, such that a person skilled in the art could understand the present disclosure in a better way and implement the present disclosure, but the embodiments illustrated do not limit the present disclosure.

As used herein, LLDPE-g-GMA represents a graft of linear low density polyethylene and glycidyl methacrylate; PBT represents polybutylene terephthalate; and PU represents polyurethane.

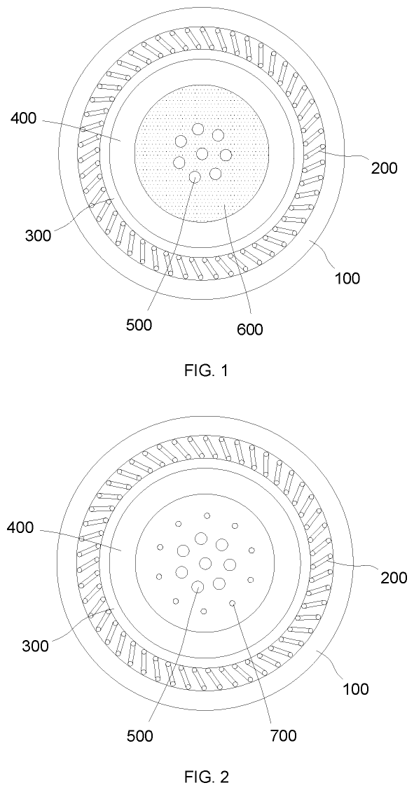

Referring to FIG. 1, a lateral pressure resistant remote optical cable includes, from outside to inside, an outer sheath 100, an elastic spiral coil 200, a water blocking reinforcement layer 300, a loose tube 400 and optical fibers 500 in turn, wherein the loose tube 400 is filled therein with an ointment 600. The outer sheath 100 has an outer diameter ranging 5.0 mm-5.5 mm, and is made of a high flame retardant, low-smoke, non-halogen material, which can meet the flame retardant requirements of optical cables of UL-OFNR level. A special mold is used in an extrusion process of the outer sheath 100, and in a process of extruding the low-smoke, non-halogen, flame retardant sheath material, generation of curtain coating can be reduced, ensuring a smooth and round appearance. The elastic spiral coil 200, made of a metal, is wrapped outside the water blocking reinforcement layer 300, with a good radial rigidity, and capability of withstanding a relatively large lateral pressure without deformation, thus functioning to protect the loose tube 400. The water blocking reinforcement layer 300, made from aramid yarns, is wrapped outside the loose tube 400, not only improving the water blocking performance, but also enhancing the tensile property of the optical cable.

A preparation method of the loose tube 400 is as follows:

### 1. Preparing Modified Graphite Nanosheets

Adding 100 mg of graphite nanosheets (the graphite nanosheets have a diameter of 80-120 nm, and a thickness of 4-6 nm) to a mixed solution of 1 mol/L sulfuric acid and 1 mol/L nitric acid, wherein a volume ratio of sulfuric acid to nitric acid is 3:1; carrying out reaction at 60° C. for at least 6 h, after suction filtration and alcohol washing, drying the mixture in vacuum at 80° C. for 6 h, to obtain acidified graphite nanosheets; then adding 50 mg of the acidified graphite nanosheets to 20 ml of tetrahydrofuran to undergo ultrasonic dispersion while stirring; subsequently adding 20 mg of dicyclohexylcarbodiimide and 80 mg of polydimethylsiloxane, and heating them to a temperature of 80° C. while stirring; after reaction for 24 h, washing a product with methanol and DMF in turn, subsequently filtering the product with a 0.22 μm filter membrane, drying a filtration product in vacuum at 50° C. to obtain silane-modified graphite nanosheets.

### 2. Preparing the Loose Tube

Adding 100 parts of PBT, 35 parts of PU, and 50 parts of LLDPE-g-GMA to a stainless steel crucible, heating them to a temperature of 280° C., and stirring them constantly for 8 h, such that raw materials are completely molten; keeping the temperature at 280° C., slowly adding 5 parts of chopped carbon fibers (with a length of 5-12 μm, and a length-diameter ratio of 20-25) while stirring, and stirring the mixture for 2 h; subsequently adding 1 part of the modified graphite nanosheets, and stirring them for 1 h; then transferring a melt to an extruder for extrusion, with an extrusion temperature being controlled at 250° C., and an extrusion speed being controlled at 180 m/min, to obtain the loose tube 400 having an outer diameter of 3.0 mm, and a wall thickness of 0.5 mm.

50 remote optical cable samples of the present embodiment are taken to test average lateral pressure resistant capacity according to an experiment method stipulated by GB/T7424.2-2008, and it is shown that the average lateral pressure resistant capacity of the optical cable samples obtained can reach 1275 N/10 cm.

Referring to FIG. 2, a lateral pressure resistant remote optical cable includes, from outside to inside, an outer sheath 100, an elastic spiral coil 200, a water blocking reinforcement layer 300, a loose tube 400 and optical fibers 500 in turn, wherein the loose tube 400 is filled therein with water blocking yarns 700. The outer sheath 100 has an outer diameter ranging 5.0 mm-5.5 mm, and is made of a high flame retardant, low-smoke, non-halogen material, which can meet the flame retardant requirements of optical cables of UL-OFNR level. A special mold is used in an extrusion process of the outer sheath 100, and in a process of extruding the low-smoke, non-halogen, flame retardant sheath material, generation of curtain coating can be reduced, ensuring a smooth and round appearance. The elastic spiral coil 200, made of a metal, is wrapped outside the water blocking reinforcement layer 300, with a good radial rigidity, and capability of withstanding a relatively large lateral pressure without deformation, thus functioning to protect the loose tube 400. The water blocking reinforcement layer 300, made from basalt fiber yarns, is wrapped outside the loose tube 400, not only improving the water blocking performance, but also enhancing the tensile property of the optical cable.

A preparation method of the loose tube 400 is as follows:

### 1. Preparing Modified Graphite Nanosheets

Adding 100 mg of graphite nanosheets (the graphite nanosheets have a diameter of 80-120 nm, and a thickness of 4-6 nm) to a mixed solution of 1 mol/L sulfuric acid and 1 mol/L nitric acid, wherein a volume ratio of sulfuric acid to nitric acid is 3:1; carrying out reaction at 60° C. for at least 6 h, after suction filtration and alcohol washing, drying the mixture in vacuum at 80° C. for 6 h, to obtain acidified graphite nanosheets; then adding 50 mg of the acidified graphite nanosheets to 20 ml of tetrahydrofuran to undergo ultrasonic dispersion while stirring; subsequently adding 20 mg of dicyclohexylcarbodiimide and 80 mg of polydimethylsiloxane, and heating them to a temperature of 80° C. while stirring; after reaction for 24 h, washing a product with methanol and DMF in turn, subsequently filtering the product with a 0.22 μm filter membrane, drying a filtration product in vacuum at 50° C. to obtain silane-modified graphite nanosheets.

### 2. Preparing the Loose Tube

Adding 120 parts of PBT, 30 parts of PU, and 60 parts of LLDPE-g-GMA to a stainless steel crucible, heating them to a temperature of 250° C., and stirring them constantly for 8 h, such that raw materials are completely molten; keeping the temperature at 250° C., slowly adding 4 parts of chopped carbon fibers (having a length of 5-12 μm, and a length-diameter ratio of 20-25) while stirring, and stirring the mixture for 2 h; subsequently adding 3 parts of modified graphite nanosheets, and stirring them for 1 h; then transferring a melt to an extruder for extrusion, with an extrusion temperature being controlled at 250° C., and an extrusion speed being controlled at 200 m/min, to obtain the loose tube 400 having an outer diameter of 2.5 mm, and a wall thickness of 0.45 mm.

50 remote optical cable samples of the present embodiment are taken to test an average lateral pressure resistant capacity according to an experiment method stipulated by GB/T7424.2-2008, and it is shown that the average lateral pressure resistant capacity of the optical cable samples obtained can reach 1215 N/10 cm.

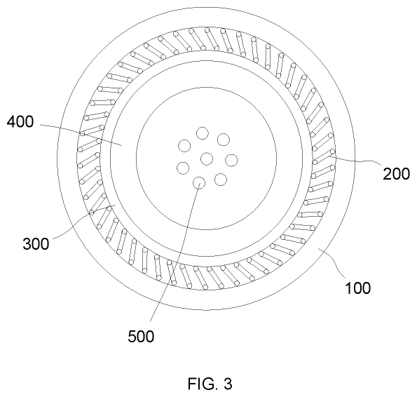

Referring to FIG. 3, a lateral pressure resistant remote optical cable includes, from outside to inside, an outer sheath 100, an elastic spiral coil 200, a water blocking reinforcement layer 300, a loose tube 400 and optical fibers 500 in turn. The outer sheath 100 has an outer diameter ranging 5.0 mm-5.5 mm, and is made of a high flame retardant, low-smoke, non-halogen material, which can meet the flame retardant requirements of optical cables of UL-OFNR level. A special mold is used in an extrusion process of the outer sheath 100, and in a process of extruding the low-smoke, non-halogen, flame retardant sheath material, generation of curtain coating can be reduced, ensuring a smooth and round appearance. The elastic spiral coil 200, made of a metal, is wrapped outside the water blocking reinforcement layer 300, with a good radial rigidity, and capability of withstanding a relatively large lateral pressure without deformation, thus functioning to protect the loose tube 400. The water blocking reinforcement layer 300, made from common reinforced fibers and water blocking yarns, is wrapped outside the loose tube 400, not only improving the water blocking performance, but also enhancing the tensile property of the optical cable.

A preparation method of the loose tube 400 is as follows:

### 1. Preparing Modified Graphite Nanosheets

Adding 100 mg of the graphite nanosheets (the graphite nanosheets have a diameter of 80-120 nm, and a thickness of 4-6 nm) to a mixed solution of 1 mol/L sulfuric acid and 1 mol/L nitric acid, wherein a volume ratio of sulfuric acid to nitric acid is 3:1; carrying out reaction at 60° C. for at least 6 h, after suction filtration and alcohol washing, drying the mixture in vacuum at 80° C. for 6 h, to obtain acidified graphite nanosheets; then adding 50 mg of the acidified graphite nanosheets to 20 ml of tetrahydrofuran to undergo ultrasonic dispersion while stirring; subsequently adding 20 mg of dicyclohexylcarbodiimide and 80 mg of polydimethylsiloxane, and heating them to a temperature of 80° C. while stirring; after reaction for 24 h, washing a product with methanol and DMF in turn, subsequently filtering the product with a 0.22 μm filter membrane, drying a filtration product in vacuum at 50° C. to obtain silane-modified graphite nanosheets.

### 2. Preparing the Loose Tube

Adding 90 parts of PBT, 25 parts of PU, and 40 parts of LLDPE-g-GMA to a stainless steel crucible, heating them to a temperature of 300° C., and stirring them constantly for 8 h, such that the raw materials are completely molten; keeping the temperature at 260° C., slowly adding 8 parts of chopped carbon fibers (having a length of 5-12 μm, and a length-diameter ratio of 20-25) while stirring, and stirring the mixture for 2 h; subsequently adding 1 part of the modified graphite nanosheets, and stirring them for 1 h; then transferring a melt to an extruder for extrusion, with an extrusion temperature being controlled at 250° C., and an extrusion speed being controlled at 160 m/min, to obtain the loose tube 400 having an outer diameter of 3.0 mm, and a wall thickness of 0.55 mm.

50 remote optical cable samples of the present embodiment are taken to test an average lateral pressure resistant capacity according to an experiment method stipulated by GB/T7424.2-2008, and it is shown that the average lateral pressure resistant capacity of the optical cable samples obtained can reach 1191 N/10 cm.

The above-mentioned embodiments are merely preferred embodiments illustrated for comprehensively explaining the present disclosure, while the scope of protection of the present disclosure is not limited thereto. All equivalent substitutions or modifications made by a person skilled in the present technical field on the basis of the present disclosure fall within the scope of protection of the present disclosure. The scope of protection of the present disclosure is determined by the claims.

### INDUSTRIAL APPLICABILITY

For the lateral pressure resistant remote optical cable in the present disclosure, PU and LLDPE-g-GMA are introduced to the conventional raw materials PBT of the loose tube for blending modification. LLDPE has excellent mechanical performances, but has unsound compatibility with a PBT substrate, while an epoxy group in GMA can react with terminal carboxyl in PBT, thus improving compatibility of LLDPE with PBT, thereby facilitating improvement on the mechanical strength of PBT; moreover, PU can endow the PBT substrate with excellent damping and buffer performances, and good compression load resistance and deformation restorability. The modified graphite nanosheets and the chopped carbon fibers are uniformly distributed in the PBT substrate material, further increasing the mechanical performances of the PBT substrate. Consequently, the lateral pressure resistant remote optical cable in the present disclosure still can maintain the optical transmission performance unaffected when bearing a lateral pressure of 10000 N/10 cm.

1. A lateral-pressure resistant remote optical cable, comprising an outer sheath, at least one loose tube provided inside the outer sheath, and optical fibers filled in the loose tube, wherein raw materials of the loose tube are of following formula: 80-120 parts of PBT, 25-40 parts of PU, 40-80 parts of LLDPE-g-GMA, 1-3 parts of modified graphite nanosheets, and 2-8 parts of chopped carbon fibers, wherein the modified graphite nanosheets have a diameter of 60-150 nm, and a thickness of 2.5-8 nm; the chopped carbon fibers have a length of 2-15 and a length-diameter ratio of 10-30;
the loose tube is prepared through following steps:
adding formula amount of PBT, PU and LLDPE-g-GMA into a container, heating them to a temperature of 240-300° C., and evenly stirring them for 4-8 h, such that the raw materials are completely molten; keeping the temperature at 250-280° C., slowly adding the chopped carbon fibers while stirring, and stirring the mixture for 1-2 h; subsequently adding the modified graphite nanosheets, and stirring them for 0.5-1 h; then transferring a melt to an extruder for extrusion, with an extrusion temperature being controlled at 230-260° C., and an extrusion speed being controlled at 160-200 m/min, to obtain the loose tube.

2. The lateral pressure resistant remote optical cable according to claim 1, wherein the loose tube is prepared by following raw materials in parts by weight: 90-100 parts of PBT, 30-38 parts of PU, and 60-80 parts of LLDPE-g-GMA, 8-12 parts of modified graphite nanosheets, and 5-6 parts of chopped carbon fibers.

3. The lateral pressure resistant remote optical cable according to claim 1, wherein a ratio of PBT to LLDPE-g-GMA is within a range of 2.5-6.

4. The lateral pressure resistant remote optical cable according to claim 1, wherein a ratio of PBT to LLDPE-g-GMA is within a range of 2.57-4.8.

5. The lateral pressure resistant remote optical cable according to claim 1, wherein the loose tube is prepared by following raw materials in parts by weight: 90-110 parts of PBT, 30-38 parts of PU, and 40-60 parts of LLDPE-g-GMA, 0.5-2 parts of modified graphite nanosheets, and 4-6 parts of chopped carbon fibers.

6. The lateral pressure resistant remote optical cable according to claim 1, wherein the modified graphite nanosheets have a diameter of 80-120 nm, and a thickness of 4-6 nm; and the chopped carbon fibers have a length of 5-12 um, and a length-diameter ratio of 18-25.

7. The lateral pressure resistant remote optical cable according to claim 1, wherein a preparation method of the modified graphite nanosheets comprises following steps:
(1) acidifying the graphite nanosheets to obtain acidified graphite nanosheets;
(2) performing ultrasonic dispersion in a medium; and
(3) adding dicyclohexylcarbodiimide and polydimethylsiloxane, reacting for at least 6 h at 75-80° C. while stirring.

8. The lateral pressure resistant remote optical cable according to claim 1, wherein a preparation method of the modified graphite nanosheets comprises following step:
adding the graphite nanosheets to a mixed solution of sulfuric acid and nitric acid, wherein a volume ratio of sulfuric acid to nitric acid is 3:1; carrying out reaction at 50-65° C. for at least 6 h, after suction filtration and alcohol washing, drying the mixture in vacuum at 70-80° C. for 4-6 h, to obtain acidified graphite nanosheets; then adding 50-80 mg of the acidified graphite nanosheets to 20 ml of tetrahydrofuran to undergo ultrasonic dispersion while stirring; subsequently adding 15-20 mg of dicyclohexylcarbodiimide and 80-90 mg of polydimethylsiloxane, and heating them to a temperature of 75-80° C. while stirring; after reaction for 12-24 h, washing a product with methanol and DMF in turn, subsequently filtering the product with a filter membrane, drying a filtration product in vacuum at 50-60° C. to obtain the modified graphite nanosheets.

9. The lateral pressure resistant remote optical cable according to claim 1, wherein the loose tube has an outer diameter of 2.5 mm-3.0 mm, and a wall thickness of 0.45 mm-0.55 mm.

10. The lateral pressure resistant remote optical cable according to claim 1, wherein the loose tube is filled therein with an ointment or water blocking yarns.

11. The lateral pressure resistant remote optical cable according to claim 1, wherein the loose tube is wrapped by a water blocking reinforcement layer outside, and the water blocking reinforcement layer is made from water blocking type reinforcement fibers, and/or mixed fibers containing common reinforcement fibers and water blocking yarns.

12. The lateral pressure resistant remote optical cable according to claim 11, wherein the water blocking type reinforcement fibers are aramid yarns, ultra-high strength PE fiber yarns, basalt fiber yarns or thermosetting glass fiber yarns.

13. The lateral pressure resistant remote optical cable according to claim 11, wherein the water blocking reinforcement layer is wrapped by an elastic spiral coil outside.

14. The lateral pressure resistant remote optical cable according to claim 1, wherein the outer sheath is a flame retardant, low-smoke, non-halogen outer sheath, which has an outer diameter of 5.0 mm-5.5 mm.

15. The lateral pressure resistant remote optical cable according to claim 1, wherein a lateral pressure resistant capacity of the lateral pressure resistant remote optical cable is greater than 1000 N/10 cm.

16. The lateral pressure resistant remote optical cable according to claim 2, wherein a preparation method of the modified graphite nanosheets comprises following step:
adding the graphite nanosheets to a mixed solution of sulfuric acid and nitric acid, wherein a volume ratio of sulfuric acid to nitric acid is 3:1; carrying out reaction at 50-65° C. for at least 6 h, after suction filtration and alcohol washing, drying the mixture in vacuum at 70-80° C. for 4-6 h, to obtain acidified graphite nanosheets; then adding 50-80 mg of the acidified graphite nanosheets to 20 ml of tetrahydrofuran to undergo ultrasonic dispersion while stirring; subsequently adding 15-20 mg of dicyclohexylcarbodiimide and 80-90 mg of polydimethylsiloxane, and heating them to a temperature of 75-80° C. while stirring; after reaction for 12-24 h, washing a product with methanol and DMF in turn, subsequently filtering the product with a filter membrane, drying a filtration product in vacuum at 50-60° C. to obtain the modified graphite nanosheets.

17. The lateral pressure resistant remote optical cable according to claim 6, wherein a preparation method of the modified graphite nanosheets comprises following step:
adding the graphite nanosheets to a mixed solution of sulfuric acid and nitric acid, wherein a volume ratio of sulfuric acid to nitric acid is 3:1; carrying out reaction at 50-65° C. for at least 6 h, after suction filtration and alcohol washing, drying the mixture in vacuum at 70-80° C. for 4-6 h, to obtain acidified graphite nanosheets; then adding 50-80 mg of the acidified graphite nanosheets to 20 ml of tetrahydrofuran to undergo ultrasonic dispersion while stirring; subsequently adding 15-20 mg of dicyclohexylcarbodiimide and 80-90 mg of polydimethylsiloxane, and heating them to a temperature of 75-80° C. while stirring; after reaction for 12-24 h, washing a product with methanol and DMF in turn, subsequently filtering the product with a filter membrane, drying a filtration product in vacuum at 50-60° C. to obtain the modified graphite nanosheets.

18. The lateral pressure resistant remote optical cable according to claim 2, wherein the loose tube has an outer diameter of 2.5 mm-3.0 mm, and a wall thickness of 0.45 mm-0.55 mm.

19. The lateral pressure resistant remote optical cable according to claim 4, wherein the loose tube has an outer diameter of 2.5 mm-3.0 mm, and a wall thickness of 0.45 mm-0.55 mm.

20. The lateral pressure resistant remote optical cable according to claim 9, wherein the outer sheath is a flame retardant, low-smoke, non-halogen outer sheath, which has an outer diameter of 5.0 mm-5.5 mm.
